(19) United States
(12) Patent Application Publication
(10) Pub. No.: US 2022/0414579 A1
(43) Pub. Date: Dec. 29, 2022

(54) SALESPERSON EVALUATION APPARATUS, SALESPERSON EVALUATION METHOD, AND SALESPERSON EVALUATION PROGRAM

(71) Applicant: VANISH STANDARD CO., LTD., Tokyo (JP)

(72) Inventor: Yasuaki ONOZATO, Tokyo (JP)

(21) Appl. No.: 17/639,785

(22) PCT Filed: Sep. 3, 2020
(86) PCT No.: PCT/JP2020/033465

§ 371 Date: Mar. 2, 2022

(30) Foreign Application Priority Data
Sep. 5, 2019 (JP) PCT/JP2019/035002

(51) Int. Cl. G06Q 10/06

(52) U.S. Cl. CPC G06Q 10/06398

(57) ABSTRACT

There is provided a status point giving unit 38 that gives a status point determined by a predetermined rule to a salesperson who sells a product based on sales status data including information indicating the implementation status of sales promotion measures taken by a salesperson using, for example, the Internet, the status of consumer reactions to the sales promotion measures, and sales performance for a product for which the sales promotion measures have been taken. By giving a status point determined by the predetermined rule to a salesperson who sells a product through sales promotion measures, even when a useful result is achieved in the sales process by taking the sales promotion measures, a point is given with the result as an evaluation target. Therefore, the motivation of the salesperson can be increased more effectively.

### TECHNICAL FIELD

The present invention relates to a salesperson evaluation apparatus, a salesperson evaluation method, and a salesperson evaluation program, and is particularly suitable for use in a system for evaluating, based on a predetermined rule, a salesperson who sells products.

### BACKGROUND ART

In the related art, there has been known a system that gives an incentive, such as a point or a bonus, to a salesperson who sells products, based on sales performance or the like, in order to increase motivation for sales (for example, refer to Patent Documents 1 to 3).

In the system described in Patent Document 1, a sales support server gives a point corresponding to the sales performance of a salesperson according to a predetermined point grant rule, and provides commemorative goods as rewards according to the number of points earned.

In the system described in Patent Document 2, a plurality of periods are set, a product to which focus is to be given for sale during the period among products handled is designated as a target product for each period, and the sales target number of target products is set for a salesperson in each store. Then, a predetermined number of points are given to the salesperson in accordance with the sales target achievement rate each time the period passes, and after the end of a series of point grant target periods, a predetermined premium is given according to the total number of points earned by the salesperson.

In the system described in Patent Document 3, an incentive (reward) is given to a salesperson who triggers a user to purchase a product using an EC site. For example, a salesperson code associated with the product code of a recommended product (product selected by a product manager) is read from an order information storage unit, and an incentive (a predetermined percentage of the amount of order of the recommended product, a predetermined amount corresponding to the number of recommended products ordered, or the like) is given to a salesperson corresponding to the salesperson code.

Patent Document 1: JP-A-2003-6422

Patent Document 2: JP-A-2001-22821

Patent Document 3: JP-A-2014-182760

### SUMMARY OF THE INVENTION

### Technical Problem

As described in Patent Documents 1 to 3, the purpose of giving incentives to salespersons according to the sales performance is to motivate each salesperson to increase sales of the entire company.

However, in the techniques described in the above Patent Documents 1 to 3, an incentive is given based on the final sales performance regardless of how the salesperson sells a product, and there is a challenge in increasing the motivation of the salesperson. That is, in the techniques described in Patent Documents 1 to 3, only the sales performance for the product is evaluated, and even if a useful result is achieved in the sales process, the result is not evaluated. For this reason, there has been a problem that the motivation of the salesperson cannot be effectively increased.

The invention has been made in order to solve such a problem, and an object thereof is to improve product sales performance by increasing the motivation of salespersons more effectively.

### Solution to Problem

In order to solve the aforementioned problem, in the invention, a status point determined by a predetermined rule is given to a salesperson who sells a product based on sales status data including information indicating the implementation status of sales promotion measures taken by a salesperson, the status of consumer reactions to the sales promotion measures, and sales performance for a product for which the sales promotion measures have been taken.

### Advantageous Effects of the Invention

According to the invention configured as described above, when a salesperson takes sales promotion measures independently, a status point is given to the salesperson based on the sales status data including the information indicating the implementation status of the sales promotion measures, the status of consumer reactions to the sales promotion measures, and the sales performance for the product for which the sales promotion measures have been taken. That is, even when a useful result is achieved in the sales process by taking the sales promotion measures, a point is given with the result as an evaluation target. Therefore, the motivation of the salesperson can be increased more effectively, so that it is possible to improve the sales performance for the product.

### BRIEF DESCRIPTION OF THE DRAWINGS

FIG. 1 is a diagram illustrating an example of the overall configuration of a salesperson evaluation system according to a present embodiment.

FIG. 2 is a block diagram illustrating a functional configuration example of the salesperson evaluation system according to the present embodiment.

FIG. 3 is a diagram illustrating an example of master data stored in a product master storage unit.

FIG. 4 is a diagram illustrating an example of sales status data (target product sales performance data) stored in a sales status data storage unit.

FIG. 5 is a diagram showing an example of sales status data (sales promotion status data) stored in the sales status data storage unit.

FIG. 6 is a flowchart illustrating an operation example of the evaluation management server according to the present embodiment.

### MODE FOR CARRYING OUT THE INVENTION

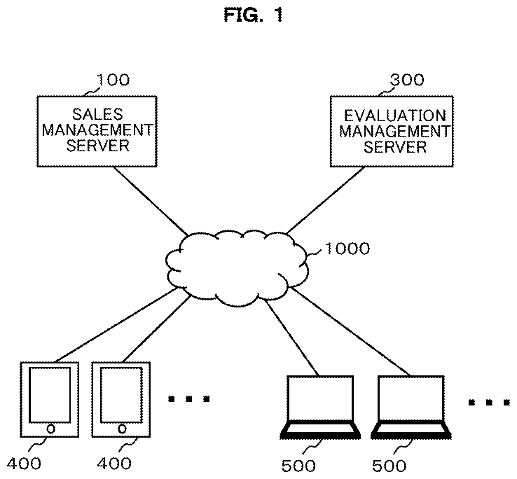

Hereinafter, an embodiment of the invention will be described with reference to the diagrams. FIG. 1 is a diagram illustrating an example of the overall configuration of a salesperson evaluation system includes a salesperson evaluation apparatus according to the present embodiment. As illustrated in FIG. 1, the salesperson evaluation system according to the present embodiment includes a sales management server 100, an evaluation management server 300, a salesperson terminal 400, and a consumer terminal 500. The sales management server 100, the evaluation management server 300, the salesperson terminal 400, and the consumer terminal 500 are communicably connected to each other through a communication network 1000, such as the Internet and a mobile phone network.

The sales management server 100 performs sales management of a product to be sold by a company (hereinafter, referred to as a sales target product). The sales management is each process required to post and sell sales target products on the EC site, each process required to take various sales promotion measures for sales target products, and each process required to count the sales status of sales target products sold through the EC site (including consumer reactions to the sales target products posted on the EC site). Details of each of these processes will be sequentially described later.

The evaluation management server 300 corresponds to a salesperson evaluation apparatus of the present invention, and performs a process of giving a point to a salesperson for evaluation based on the sales status of the sales target product by the salesperson managed by the sales management server 100. Details of the evaluation management server 300 will be described later.

The salesperson terminal 400 is a terminal used by a salesperson in a company that sells a sales target product, and is, for example, a smartphone, a tablet terminal, a personal computer, or the like. The consumer terminal 500 is a terminal used by a consumer who purchases a sales target product, and is, for example, a smartphone, a tablet terminal, a personal computer, or the like. Note that, although FIG. 1 illustrates that the salesperson terminal 400 is a smartphone and the consumer terminal 500 is a personal computer for easy distinction, the invention is not limited thereto.

Note that, although FIG. 1 illustrates an example in which servers are divided into two, that is the sales management server 100 and the evaluation management server 300, the invention is not limited thereto. For example, the sales management server 100 and the evaluation management server 300 may be configured as one server.

FIG. 2 is a block diagram illustrating the functional configuration of the salesperson evaluation system according to the present embodiment, specifically, a functional configuration example of the sales management server 100 and the evaluation management server 300. As illustrated in FIG. 2, the sales management server 100 includes a sales management unit 11 and a sales status recording unit 12 as functional components. In addition, the sales management server 100 includes a product master storage unit 101 and a sales status data storage unit 102 as storage media.

Each of the functional blocks 11 and 12 can be configured by any of hardware, a digital signal processor (DSP), and software. For example, when configured by software, each of the functional blocks 11 and 12 is actually configured to include a CPU, a RAM, and a ROM of a computer, and is realized by the operation of a program stored in a recording medium, such as a RAM, a ROM, a hard disk, or a semiconductor memory.

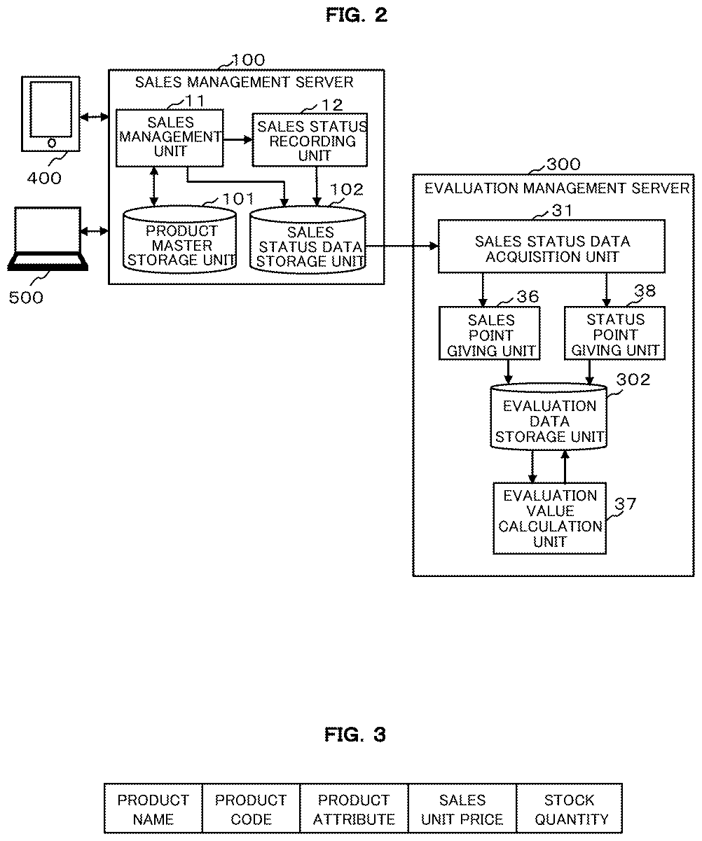

The product master storage unit 101 stores master data regarding a plurality of sales target products. FIG. 3 is a diagram illustrating an example of master data stored in the product master storage unit 101. As illustrated in FIG. 3, the product master storage unit 101 stores data, such as a product name, a product code, product attributes, a sales unit price and a stock quantity, for each of a plurality of sales target products. Note that, the data described herein is merely an example, and the master data may include other pieces of data.

The product attributes are information for specifying different attributes when the same product has different attributes. In the present embodiment, clothes will be described as an example of a sales target product. In this case, the product attributes are the color, size, or the like of the product. The stock quantity is the number of sales target products purchased by the company as expected to be sold. When the same sales target products are purchased multiple times, the total number of purchases becomes the stock quantity.

The sales management unit 11 performs various processes required to post and sell the sales target product on the EC site and various processes required to take various sales promotion measures for the sales target product. In the present embodiment, the sales management unit 11 performs processing in which a salesperson operates the salesperson terminal 400 to select an arbitrary sales target product from a plurality of sales target products stored in the product master storage unit 101 and post the selected sales target product on the EC site. The EC site in this case is a personal EC site in which a salesperson selects and posts a sales target product by himself or herself. A support application (hereinafter, referred to as a sales support application) that makes it possible to access the sales management server 100 and perform such processing is installed on the salesperson terminal 400.

Thus, in response to the request from the salesperson terminal 400, the sales management unit 11 performs a process of creating a personal EC site for each of a plurality of salespersons and posting the sales target product selected by each salesperson. The sales management unit 11 stores information regarding which sales target product is posted on which sales person's EC site (in other words, which sales person sells which sales target product), as one of the sales status data, in the sales status data storage unit 102 and manages the information. In addition, the sales management unit 11 stores information regarding which salesperson takes what kind of sales promotion measures at which EC site, as one of the sales status data, in the sales status data storage unit 102 and manages the information.

Note that, although the example in which an EC site is created for each salesperson has been described herein, the invention is not limited thereto. For example, one EC site may be prepared by a company, and a sales page for each salesperson may be created in the EC site and sales target products selected by each salesperson are posted on the sales page of each salesperson.

In addition, as an example of the processing required for the salesperson to take sales promotion measures for the sales target product, the sales management unit 11 performs a process of posting a coordinate, which is a combination of several sales target products, on the EC site, a process of posting comments on easy-to-understand points or features from the salesperson's point of view on the sales target product on the EC site, and a process of posting the sales target product, comments on the sales target product, and the like on the salesperson's personal SNS (Instagram, Facebook, LINE, and the like all of which are registered trademarks). The coordinate posting function, the comment posting function, and the SNS posting function are also implemented in the sales support application.

In addition, the sales management unit 11 also performs a process relevant to the purchase of a sales target product, which is performed through access to the EC site from the consumer terminal 500. The consumer can browse a plurality of sales target products on a desired EC site and perform a series of procedures for selecting and purchasing a desired sales target product from the plurality of sales target products, and the series of procedures is executed by the sales management unit 11.

The sales status recording unit 12 performs a process of recording, in the sales status data storage unit 102, information regarding the sales status of a sales target product sold through each salesperson's EC site, the implementation status of sales promotion measures taken by the salesperson, and the like.

For example, when consumers purchase sales target products through the EC site, the sales status recording unit 12 acquires information, which indicates when and how many sales target products have been sold from which sales person's EC site, from the sales management unit 11, and records the information in the sales status data storage unit 102 as one of the sales status data.

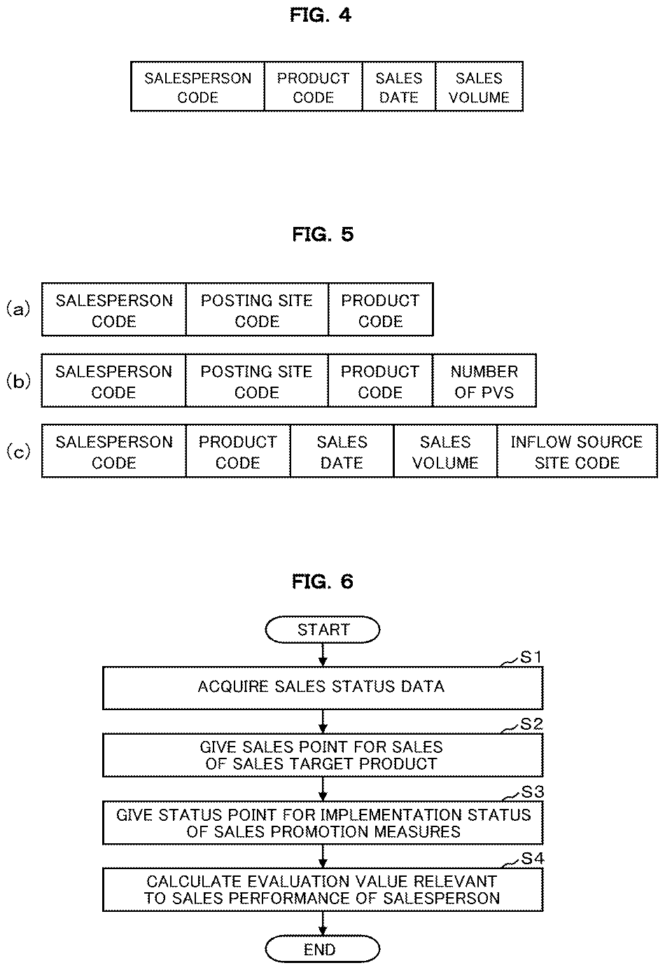

FIG. 4 is a diagram showing an example of sales status data stored in the sales status data storage unit 102. As shown in FIG. 4, the sales status data storage unit 102 stores a salesperson code, a product code, a sales date of a sales target product, and a sales volume in one record so as to be associated with each other, for each of a plurality of salespersons and for each sales target product selected and sold by the salesperson. Regarding to the record in which the data is stored, one record is added each time the sales management unit 11 detects that the sales target product has been purchased by the consumer.

Note that, FIG. 4 shows an example of a method of storing sales status data in the sales status data storage unit 102, and the invention is not limited thereto. The point is that the data should be stored in a form that allows it to be understood by which salesperson which sales target product was sold and when and how many.

In addition, the sales status recording unit 12 records, as sales status data, data regarding the implementation status of sales promotion measures taken by the salesperson, data regarding the status of consumer reactions to the sales promotion measures, and data regarding the sales performance for the sales target product for which the sales promotion measures have been taken, in the sales status data storage unit 102. FIG. 5 is a diagram showing an example of these pieces of sales status data stored in the sales status data storage unit 102.

The data regarding the implementation status of sales promotion measures taken by the salesperson (hereinafter, referred to as sales promotion implementation status data) is data indicating the implementation status of sales promotion measures taken by the salesperson using the coordinate posting function, the comment posting function, and the SNS posting function of the sales support application. Specifically, as shown in FIG. 5(a), the sales promotion implementation status data includes a salesperson code, a posting site code indicating the EC site where the salesperson posted the sales target product, and information indicating the sales target product to be posted (product code or product name). When a plurality of sales target products are posted using the coordinate posting function, the product codes of the plurality of products included in the coordinate are recorded. Regarding to the record in which the data is stored, for example, one record is added each time a salesperson performs posting.

As shown in FIG. 5(b), the data regarding the status of consumer reactions to the sales promotion measures (hereinafter, referred to as sales promotion reaction status data) includes information, such as a salesperson code, a posting site code indicating the EC site where the salesperson posted the sales target product, a product code of the sales target product posted by the salesperson, and the number of PVs. Regarding to the record in which the data is stored, for example, one record is added each time a salesperson performs posting, and the number of PVs recorded in each record is added each time the corresponding posting site is viewed by a consumer.

The number of PVs is the number of times a page on which a sales target product is posted was opened. For example, in a case where the EC site is configured to transition to an individual page, on which detailed information of the sales target product is posted, in response to an operation of selecting a certain sales target product by the consumer on a page on which a plurality of sales target products are listed, the number of times an individual page is opened can be the number of PVs.

In addition, as shown in FIG. 5(c), the data regarding the sales performance for the sales target product (hereinafter, referred to as sales promotion product sales performance data) includes information, such as a salesperson code; a product code, a sales date and a sales volume of the sold sales target product; and a posting site code indicating the inflow source of which EC site (posting site) was accessed to sell the sales target product. Regarding to the record in which the data is stored, one record is added each time the sales management unit 11 detects that the sales target product has been purchased by the consumer.

Note that, in the following, the sales status data shown in FIG. 4 is referred to as “target product sales performance data”, and the sales status data shown in FIG. 5 is referred to as “sales promotion status data” to distinguish between the two. Here, the sales status data has been described separately in FIGS. 4 and 5, but this is merely for convenience of explanation, and it is not essential to physically divide the data into two storage media for storage.

Next, the configuration of the evaluation management server 300 will be described. As illustrated in FIG. 2, the evaluation management server 300 includes, as functional components, a sales status data acquisition unit 31, a sales point giving unit 36, status point giving unit 38 and an evaluation value calculation unit 37. In addition, the evaluation management server 300 includes an evaluation data storage unit 302 as storage media.

Each of the functional blocks 31 and 36 to 38 can be configured by any of hardware, a DSP, and software. For example, when configured by software, each of the functional blocks 31 and 36 to 38 is actually configured to include a CPU, a RAM, and a ROM of a computer, and is realized by the operation of a program stored in a recording medium, such as a RAM, a ROM, a hard disk, or a semiconductor memory. This program corresponds to a salesperson evaluation program described in the claims.

The sales status data acquisition unit 31 acquires sales status data (sales status data stored in the sales status data storage unit 102), which indicates the sales status of a plurality of sales target products targeted for sale by the company, from the sales management server 100. The sales status data acquired by the sales status data acquisition unit 31 is the target product sales performance data shown in FIG. 4 and the sales promotion status data shown in FIG. 5 (at least one of sales promotion implementation status data, sales promotion reaction status data, and sales promotion product sales performance data). The sales status data acquisition unit 31 supplies the target product sales performance data to the sales point giving unit 36, and supplies the sales promotion status data to the status point giving unit 38.

The sales status data acquisition unit 31 performs the process of acquiring the sales status data from the sales management server 100 periodically, for example, at predetermined time intervals. The predetermined time interval is, for example, every other month. Here, the sales status data acquisition unit 31 acquires only the sales status data stored in the sales status data storage unit 102 during the latest time interval (hereinafter, referred to as an evaluation target period).

Each time the sales status data acquisition unit 31 acquires the sales status data, the sales point giving unit 36, status point giving unit 38 and the evaluation value calculation unit 37 perform a process of giving a point and a process of calculating an evaluation value, which will be described below, based on the sales status data during the evaluation target period. The interval (the length of the evaluation target period) at which a point is given and the evaluation value is calculated may be set in accordance with the timing at which a predetermined incentive (for example, salary, bonus, premium corresponding to the evaluation value, or the like) is given to the salesperson.

Based on the target product sales performance data acquired by the sales status data acquisition unit 31, the sales point giving unit 36 gives a point, which is determined by a predetermined rule for each of sold sales target products, to a salesperson who sells the sales target products. For example, the sales point giving unit 36 gives a predetermined point to the salesperson each time one sales target product is sold.

Here, the point is a numerical value used when the evaluation value calculation unit 37 calculates the evaluation value of each salesperson, and may be called a score. The predetermined rule is, for example, a rule for giving a point as a fixed value for sales of a sales target product. Note that, a rule for giving different points to different sales target products may be set. The contents of the rule can be set arbitrarily.

The sales point giving unit 36 calculates, for each salesperson, a sales point by adding up the points given as described above for respective sales target products sold per unit period. Then, the sales point giving unit 36 stores the calculated sales point in the evaluation data storage unit 302 so as to be managed for each salesperson.

The status point giving unit 38 calculates a status point from at least one of the implementation status of sales promotion measures, the consumer reaction status, and the sales performance for the sales target product based on the sales promotion status data (at least one of the sales promotion implementation status data, the sales promotion reaction status data, and the sales promotion product sales performance data) acquired by the sales status data acquisition unit 31.

Here, the status point giving unit 38 calculates the status point using at least one of the following parameters (A) to (G), for example.

(A) Salesperson's sales figure: total sales figure of sales promotion target products sold by a salesperson during a unit period

(B) The number of posted contents: the total number of contents posted by coordinate posting, comment posting, and SNS posting. The content means a coordinate when a combination of a plurality of sales target products is posted as a coordinate, and means one sales target product when the one sales target product is posted.

(C) Average sales figure of one content: average sales figure of each piece of posted content

(D) The number of PVs: the total number of PVs of all contents posted by a salesperson during a unit period

(E) The number of customers attracted by SNS: the number of customers attracted by the salesperson's personal SNS among all customers for a sales target product sold by a salesperson during a unit period

(F) Sales figure through SNS: Total sales figure of sales target products sold to customers attracted by the salesperson's personal SNS among sales target products sold by a salesperson during a unit period

(G) Sales figure through posting to other EC sites: Total sales figure of sales target products sold to customers attracted by EC sites on which the sales target products are posted by coordinate posting and comment posting

That is, the status point giving unit 38 calculates a status point using a predetermined function using at least one of the above-described (A) to (G) as an explanatory variable and the status point as a target variable. For example, the predetermined function used by the status point giving unit 38 to calculate the status point is designed so that the status point increases as the value of any of the parameters (A) to (G) increases. In addition, priorities may be set for the parameters (A) to (G), and the function may be designed so that the status point increases as the value of the parameter with higher priority increases.

The evaluation value calculation unit 37 calculates an evaluation value regarding the sales performance of the salesperson per unit period by using the sales point calculated by the sales point giving unit 36 and the status point calculated by the status point giving unit 38. For example, the evaluation value calculation unit 37 calculates the evaluation value of the salesperson by adding up the sales point and the status point or multiplying the sales point and the status point together. In this manner, it is possible to reflect the sales performance for the sales target product, as a sales point, in the evaluation value while reflecting the sales performance or the implementation status of sales promotion measures taken by the salesperson, as a status point, in the evaluation value.

The evaluation value calculation unit 37 may calculate the evaluation value of the salesperson based on an arbitrary function that uses the sales point and the status point as variables. For example, when calculating the evaluation value of the salesperson from the sales point and the status point, the evaluation value calculation unit 37 may calculate the evaluation value based on a function in which the percentage of the sales point reflected in the evaluation value is equal to or greater than the percentage of the status point reflected in the evaluation value. In this manner, it is possible to calculate the evaluation value of each salesperson in a state in which the sales performance for the sales target product is more strongly reflected while reflecting the implementation status of sales promotion measures taken by the salesperson for all sales target products.

Then, the evaluation value calculation unit 37 stores the calculated evaluation value in the evaluation data storage unit 302 so as to be managed for each salesperson. Here, the unit period is an evaluation target period (for example, one month) at a predetermined time interval in which the sales point giving unit 36, the status point giving unit 38, and the evaluation value calculation unit 37 perform processes.

FIG. 6 is a flowchart showing an operation example of the salesperson evaluation system according to the present embodiment configured as described above. FIG. 6 shows an operation example of calculating an evaluation value by giving a point in the evaluation management server 300. The operation of the evaluation management server 300 shown in FIG. 6 is repeatedly performed at predetermined time intervals (for example, every other month).

First, the sales status data acquisition unit 31 acquires sales status data (target product sales performance data shown in FIG. 4 and sales promotion status data shown in FIG. 5) of a plurality of sales target products from the sales management server 100 (step S1). Then, the sales point giving unit 36 gives a sales point to the salesperson who sells the sales target product based on the target product sales performance data acquired by the sales status data acquisition unit 31, and stores the sales point in the evaluation data storage unit 302 (step S22).

In addition, the status point giving unit 38 gives a status point to the salesperson who takes sales promotion measures for the sales target product based on the sales promotion status data acquired by the sales status data acquisition unit 31, and stores the status point in the evaluation data storage unit 302 (step S3).

In addition, the evaluation value calculation unit 37 calculates, for each salesperson, an evaluation value relevant to the sales performance of the salesperson per unit period by using the sales point given by the sales point giving unit 36 and the status point calculated by the status point giving unit 38, and stores the calculated evaluation value in the evaluation data storage unit 302 (step S4).

As described in detail above, in the present embodiment, based on the sales status data including information indicating the implementation status of the sales promotion measures taken by the salesperson, the status of consumer reactions to the sales promotion measures, and sales performance for the product for which the sales promotion measures have been taken, a status point determined by the predetermined rule is given to the salesperson who takes the sales promotion measures.

According to the present embodiment configured in this manner, when a useful result is achieved in the sales process by taking the sales promotion measures, a status point is given with the result as an evaluation target. Therefore, the motivation of the salesperson can be increased more effectively, so that it is possible to improve the sales performance for the product.

In addition, in the present embodiment, based on the target product sales performance data regarding the sales target product, a sales point determined by the predetermined rule is also given to the salesperson who sells the sales target product. According to the present embodiment configured in this manner, in addition to the status point being given according to the implementation status of the sales promotion measures taken by the salesperson, the sales point is given according to the sales performance for the sales target product. Therefore, the motivation of the salesperson can be increased more effectively, so that it is possible to improve the sales performance for the product.

Note that, in the above embodiment, an example has been described in which the sales point and the status point are calculated and the evaluation value of the salesperson is calculated by using both the sales point and the status point. However, the invention is not limited to this. For example, only the status point may be calculated without calculating the sales point. In this case, the status point may be used as it is as an evaluation value of the salesperson, or the evaluation value may be calculated by using an arbitrary function that uses the status point as a variable.

In addition, in the present embodiment, an example has been described in which a salesperson selects a sales target product by himself or herself from the product master to create a personal EC site. However, the invention is not limited thereto. For example, there may be a configuration in which there is one EC site on which all sales target products are posted and a salesperson creates a sales promotion site separately from the EC site and links the sales promotion site to the EC site. In addition, instead of the salesperson selecting and selling a sales target product by himself or herself, all the products stored in the product master may be set as sales target products of the salesperson. Alternatively, a product designated by the company from the product master or a product automatically designated by the sales management unit 11 based on a predetermined rule may be set as a sales target product of the salesperson.

In addition, in the present embodiment, an example has been described in which the evaluation value calculation unit 37 calculates the evaluation value per unit period each time the evaluation target period passes. However, the invention is not limited thereto. For example, each time the evaluation target period passes, the evaluation value of the salesperson for the entire period may be calculated using the sales status data of the entire period stored in the sales status data storage unit 102. Alternatively each time the evaluation target period passes, the latest evaluation value may be calculated only for the sales status data newly stored in the sales status data storage unit 102 during the latest time interval, and this may be accumulated in the past evaluation value.

In addition, in the present embodiment, an example has been described in which the points given by the sales point giving units 36 and the status point giving unit 38 are simple numerical values that are used when the evaluation value calculation units 37 calculate the evaluation value of the salesperson. However, the invention is not limited thereto. For example, the evaluation value calculation units 37 may be eliminated, and the points given by the sales point giving units 36 and the status point giving unit 38 may be points having economic value that can be used in actual commercial transactions.

In addition, in the present embodiment, a case where the sales target product is clothes has been described as an example. However, the sales target product is not limited to clothes. All products can be sales targets. In addition, products to be handled may be either products as goods or products as a service.

In addition, in the present embodiment, a case where products are sold at the EC site has been described as an example. However, the invention can also be applied to a case where products are sold at an actual store. For example, it is possible to acquire data regarding the sales performance for a product and a salesperson in charge from a point of sale (POS) system, which is used when selling the product at an actual store, and execute the same processing as the processing described in the present embodiment using the data acquired from the POS system. Here, the data indicating the salesperson in charge may be specified, for example, by reading a two-dimensional code.

In addition, each of the present embodiment is merely an example of implementation in carrying out the invention, and these should not be interpreted as limiting the technical scope of the invention. That is, the invention can be implemented in various forms without departing from the gist or main features thereof.

Reference Signs List

| | |
|---|---|
| 11 | Sales management unit |
| 12 | Sales status recording unit |
| 31 | Sales status data acquisition unit |
| 36 | Sales point giving unit |
| 37 | Evaluation value calculation unit |
| 38 | Status point giving unit |
| 100 | Sales management server |
| 300 | Evaluation management server (salesperson |
| | evaluation apparatus) |
| 400 | Salesperson terminal |
| 500 | Consumer terminal |

1. A salesperson evaluation apparatus, comprising:
a sales status data acquisition unit that acquires sales status data indicating a status of sales of a plurality of products, the sales status data including at least one of pieces of information indicating an implementation status of sales promotion measures taken by a salesperson, a status of consumer reactions to the sales promotion measures, and sales performance for a product for which the sales promotion measures have been taken; and
a status point giving unit that gives a status point determined by a predetermined rule to a salesperson who sells the product based on the sales status data acquired by the sales status data acquisition unit.

2. The salesperson evaluation apparatus according to claim 1,
wherein the sales status data acquired by the sales status data acquisition unit includes information indicating a salesperson and a product sold by the salesperson, and
further comprises a sales point giving unit that gives a sales point determined by a predetermined rule to a salesperson who sells the product based on the sales status data acquired by the sales status data acquisition unit.

3. The salesperson evaluation apparatus according to claim 1, further comprising:
an evaluation value calculation unit that calculates, for each salesperson, an evaluation value relevant to sales performance of the salesperson by using the status point per unit period given by the status point giving unit based on the sales status data.

4. The salesperson evaluation apparatus according to claim 2, further comprising:
an evaluation value calculation unit that calculates, for each salesperson, an evaluation value relevant to sales performance of the salesperson by using the sales point per unit period given by the sales point giving unit based on the sales status data and the status point per the unit period given by the status point giving unit based on the sales status data.

5. The salesperson evaluation apparatus according to claim 4,
wherein the evaluation value calculation unit calculates the evaluation value based on a function in which a ratio of the sales point reflected in the evaluation value is equal to or greater than a ratio of the status point reflected in the evaluation value.

6. A salesperson evaluation method, comprising:
a first step in which a sales status data acquisition unit of a computer acquires sales status data indicating a status of sales of a plurality of products, the sales status data including at least one of pieces of information indicating an implementation status of sales promotion measures taken by a salesperson, a status of consumer reactions to the sales promotion measures, and sales performance for a product for which the sales promotion measures have been taken; and
a second step in which a status point giving unit of the computer gives a status point determined by a predetermined rule to a salesperson who sells the product based on the sales status data acquired by the sales status data acquisition unit.

7. A salesperson evaluation program causing a computer to function as:
sales status data acquisition means for acquiring sales status data indicating a status of sales of a plurality of products, the sales status data including at least one of pieces of information indicating an implementation status of sales promotion measures taken by a salesperson, a status of consumer reactions to the sales promotion measures, and sales performance for a product for which the sales promotion measures have been taken; and
status point giving means for giving a status point determined by a predetermined rule to a salesperson who sells the product based on the sales status data acquired by the sales status data acquisition means.

8. A salesperson evaluation apparatus, comprising:
a sales status data acquisition unit that acquires sales status data indicating a status of sales of a plurality of products and indicating an implementation status as implementation contents of sales promotion measures taken by a salesperson; and
a status point giving unit that gives a status point determined by a predetermined rule to the salesperson based on the sales status data acquired by the sales status data acquisition unit.

9. The salesperson evaluation apparatus according to claim 8,
wherein the sales status data acquisition unit acquires sales status data further including information indicating a reaction status that is contents of reactions to the sales promotion measures other than consumer's product purchase.

10. The salesperson evaluation apparatus according to claim 8,
wherein the sales status data acquisition unit acquires sales status data further including information indicating sales performance that is sales performance relevant to consumer's purchase of a product for which the sales promotion measures have been taken.

11. The salesperson evaluation apparatus according to claim 8,
wherein the sales promotion measures include at least one of a process of posting a coordinate configured as a combination of a plurality of products on a product sales site, a process of posting comments on easy-to-understand points or features of a product from a salesperson's perspective on the product sales site, and a process of posting a product and comments on the product on an SNS of an individual salesperson.

12. The salesperson evaluation apparatus according to claim 9,
wherein the sales status data acquisition unit acquires sales status data further including information indicating sales performance that is sales performance relevant to consumer's purchase of a product for which the sales promotion measures have been taken.

13. The salesperson evaluation apparatus according to claim 9,
wherein the sales promotion measures include at least one of a process of posting a coordinate configured as a combination of a plurality of products on a product sales site, a process of posting comments on easy-to-understand points or features of a product from a salesperson's perspective on the product sales site, and a process of posting a product and comments on the product on an SNS of an individual salesperson.

14. The salesperson evaluation apparatus according to claim 10,
wherein the sales promotion measures include at least one of a process of posting a coordinate configured as a combination of a plurality of products on a product sales site, a process of posting comments on easy-to-understand points or features of a product from a salesperson's perspective on the product sales site, and a process of posting a product and comments on the product on an SNS of an individual salesperson.
